(19) United States
(12) Patent Application Publication
(10) Pub. No.: US 2015/0363698 A1
(43) Pub. Date: Dec. 17, 2015

(54) DYNAMIC CONTENT DELIVERY BASED ON HIGH-AFFINITY VIEWER POINTS

(71) Applicant: International Business Machines Corporation, Armonk, NY (US)

(72) Inventors: Barry A. Kritt, Atlantic Beach, NC (US); Sandeep R. Patil, Pune (IN); Sarbajit K. Rakshit, Kolkata (IN)

(21) Appl. No.: 14/305,073

(22) Filed: Jun. 16, 2014

(51) Int. Cl. G06N 5/04

(52) U.S. Cl. CPC G06N 5/04

(57) ABSTRACT

Identify the presence of people in a particular area and determine the object of visual attention of each person. Based on this information, select and deliver content through nearby adaptive content delivery devices based on characteristics of these objects when considered collectively, such as based on the object attracting the greatest amount of attention from passers-by. Content selection criteria may additionally be based on supplemental information, whether explicit or inferred, about the people in the area.

### BACKGROUND OF THE INVENTION

The present invention relates generally to the field of context-aware computing, and more particularly to adaptive content delivery based on recipient characteristics.

One common use for adaptive content is in the domain of targeted advertising, where advertising content is displayed or otherwise provided based on characteristics of the target audience. These characteristics may include demographics, psychographics, or other behavioral variables (such as purchase history) of the target audience. The target audience may be defined broadly (for example, middle-aged consumers in the northeastern United States) or narrowly (a specific individual consumer), and the characteristics of that audience may likewise be known to varying degrees of specificity.

Addressable systems for delivering targeted advertisements are known. Each addressable advertising system end point—such as a website or a digital sign, billboard, or hoarding—is capable of serving up an ad independently of other end points based on consumer attributes associated with that end point at the time the ad is served.

### SUMMARY

According to three aspects of the present invention there is a method, computer program product and/or system which performs the following steps (not necessarily in the following order): (i) determines one or more objects of visual attention for each person in a plurality of people; (ii) selects a first adaptive content to be presented through a first adaptive content presentation device based, at least in part, on collective consideration of the objects of visual attention of the plurality of people; and (iii) presents the first adaptive content through the first device. Membership in the plurality of people is based, at least in part, on proximity to the first device. Selection of the first adaptive content is based, at least in part, on collective consideration of the objects of visual attention of the plurality of people.

### BRIEF DESCRIPTION OF THE DRAWINGS

FIG. 1 is a schematic view of a first embodiment of a system according to the present invention;

FIG. 2 is a flowchart showing a first embodiment of a method performed, at least in part, by the first embodiment system;

FIG. 3 is a schematic view of a machine logic (for example, software) portion of the first embodiment system;

FIG. 4 is a diagram of a first physical space associated with the first embodiment system;

FIG. 5 is a diagram of a set of faces according to the present invention;

FIG. 6 is a diagram of a second physical space associated with a second embodiment system; and

FIG. 7 is a flowchart showing a second embodiment of a method performed, at least in part, by the second embodiment system.

### DETAILED DESCRIPTION

Some embodiments of the present invention identify the presence of people in a particular area and determine the object of visual attention of each person. Based on this information, content is delivered through nearby adaptive content delivery devices based on characteristics of these objects when considered collectively, such as based on the object attracting the greatest amount of attention from passers-by. The decision about what content to deliver may be supplemented by additional information, explicit or inferred, about the people in the area.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

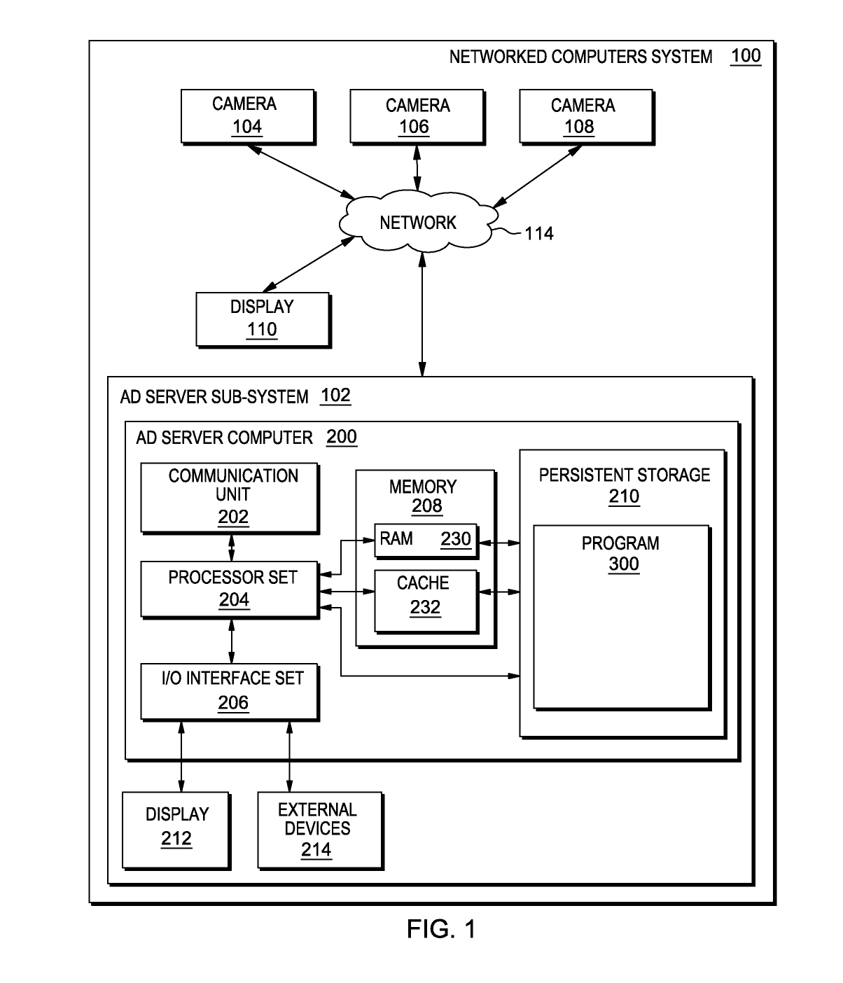

An embodiment of a possible hardware and software environment for software and/or methods according to the present invention will now be described in detail with reference to the Figures. FIG. 1 is a functional block diagram illustrating various portions of networked computers system 100, including: advertisement (ad) server sub-system 102; sensor (camera) sub-systems 104, 106, and 108; adaptive content display sub-system 110; communication network 114; ad server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Example Embodiment

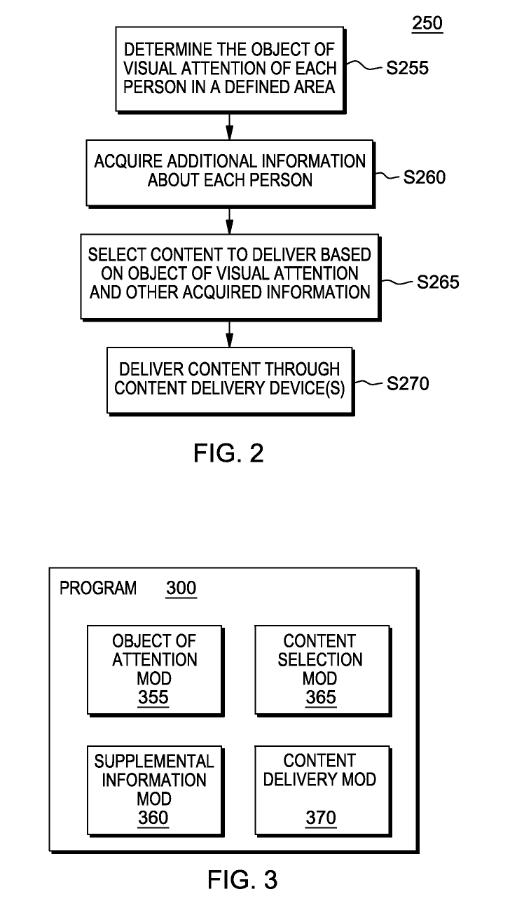

FIG. 2 shows flowchart 250 depicting a method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

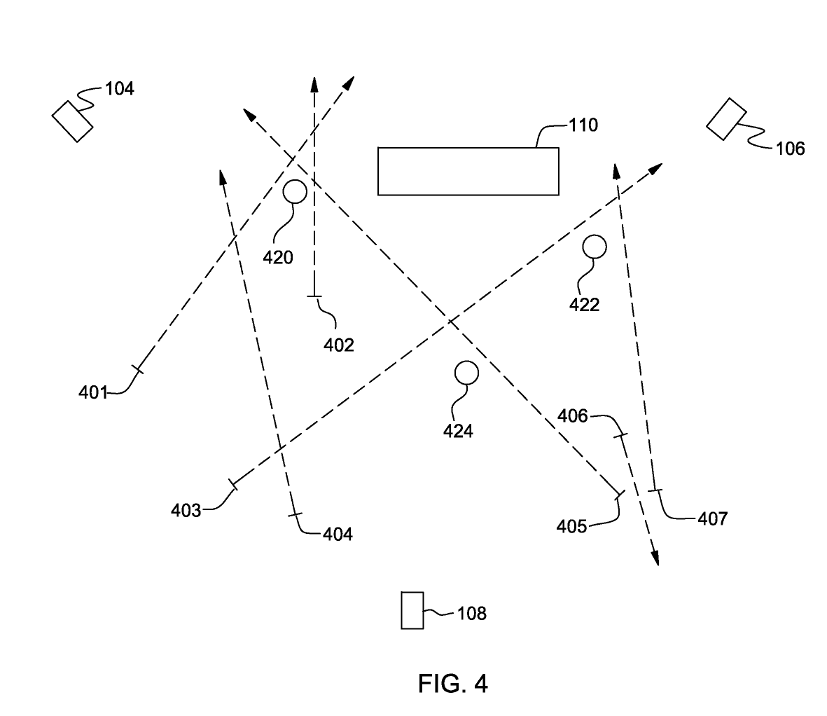

Processing begins at step S255, where object of attention module “mod” 355 determines one or more objects of visual attention of each person in a particular area. This is done through analysis of image data collected via cameras 104, 106, and 108 (see FIG. 1), which are all positioned to capture footage of the same general area from different vantage points. This area is depicted from an overhead perspective in FIG. 4, which includes cameras 104, 106, and 108; adaptive content display 110 (see also FIG. 1); people 401, 402, 403, 404, 405, 406, and 407; and products 420, 422, and 424. Video footage is gathered, facial recognition technology determines the presence of faces in that footage, and the angle of each face allows a determination of the plane of the face. From this, the direction of attention is determined to be perpendicular to that plane, defining a ray. This is visually depicted in FIG. 4 by the “T” symbol used to represent each person, where the short side of the “T” represents the plane of the face and the long side represents the inferred direction of attention. The analysis is done in two dimensions, meaning only orientation in the horizontal plane is considered.

Rays from different people will cross or become near to each other at certain points, and any object or objects near these points are determined to be an object of attention for each of those people. For example, in FIG. 4, product 420 is determined to be an object of attention for people 401, 402, 404, and 405, because it is near the spot where the ray of each of those people crosses the ray of another person. Note that this can result in multiple objects of attention being assigned to a given person, such as person 405, who is also determined to be giving attention to product 424. Alternatively, each person could be limited to a single object of attention, such as by selecting the object with the least angular deviation from that person's determined ray of attention or selecting the object closest to that person's position, or a person's attention could be apportioned among multiple objects. Furthermore, identifying the object of attention for each person could alternatively be done independently from any other person, such as by selecting the nearest object or objects to a given person in terms of angular deviation from that person's determined ray of attention, all objects of interest (such as products for sale) within a certain angular deviation from that ray, or an item being held or touched by that person.

The footage in this embodiment is supplied in a standard, continuous video format, but other modalities could be used. These include, but are not necessarily limited to: (i) capturing other parts of the electromagnetic spectrum such as infrared; (ii) varying the frequency of capture or analysis so that, say, visual snapshots are taken at 5 second intervals instead of substantially continuously; (iii) activating the capture mechanism on cue such as by motion or proximity detection technologies, and/or (iv) using other technologies to obtain information about position and orientation, such as a network of RFID tags or voluntary individual reporting via smartphone devices or other direction-sensing technology. The camera(s) or other sensor(s) may be positioned in any effective manner, including overhead, underfoot, or embedded within the adaptive content delivery devices or product showcases.

Having multiple views of the same person from different cameras at the same time may improve the accuracy of the orientation analysis. Similarly, comparing changes over time from one or more views and/or comparing current location and orientation information with historic behavior of people similarly situated may permit future orientations to be predicted. The analysis could be modified in other ways as well, such as by including body orientation information, orientation information in three dimensions (or, for a simpler analysis, in one dimension), and/or eye position or eye focal point information.

Processing proceeds to step S260, where supplemental information mod 360 acquires additional information about the people identified in the previous step. This information includes an estimate of the age and gender of each person based on further analysis of the video footage collected above. Alternatively, it could include estimates of mood, determinations of style or brands of clothing worn, or more specific information about an individual if that individual has, for instance, opted-in to sharing certain personal profile, purchase history, or social media information with the system. Here, the estimated age and gender information is aggregated to obtain a general profile of the group as a whole, then public information sources, including social media, are searched to determine trending topics for people who fit that profile. This information is then inferentially applied to the people in the group. Alternatively, separate profiles could be generated for each group of people who share the same object of attention, or this step could be skipped entirely. In any case, given the numerous types of information that could be collected and the various ways in which that information could be analyzed, it is important to keep in mind that different regions and jurisdictions may have different laws, regulations, and social norms and mores. Although such social constructs are subject to change over time, care should be taken to remain within applicable legal and social boundaries at all times.

Processing proceeds to step S265, where content selection mod 365 selects content to deliver through adaptive content display 110. Here, a chief consideration when determining what content to deliver is the object of attention attracting the greatest number of viewers—in this case, product 420. The supplementary information built up about the group as a whole—here average age and gender, and trending social media topics related to that demographic—is also used. Alternatively, the supplementary information used for selection could be derived based only those people looking at the most popular object of attention at any given time.

One of skill in the art would recognize that many variations are possible. Content could be chiefly based on the object attracting the greatest aggregate duration of attention over some interval of time, some common characteristic of multiple objects of attention (for example, perhaps the two objects attracting the most attention are both red), multiple independent or coordinated displays could be used, or the content may be audio or olfactory content related to the selected object of attention. Ads or other content could be selected in accordance with other determined characteristics of the selected group, such as modal age range, dress style, or current interests as derived from shared profile or social networking information. Displays may be fixed or mobile, flat or three-dimensional, unitary or divisible, and single or multi-modal (for example, video and audio), and these other properties may also be selected or manipulated in response to group characteristics (for instance, a display may be rotated or divided in half). In this way, ads or other communications can be selected or refined to more effectively reach the current audience.

Finally, processing proceeds to step S270, where content delivery mod 370 delivers the selected content (an advertisement in this case) via the chosen device.

### III. Further Comments and/or Embodiments

Some embodiments of the present invention recognize the following facts, potential problems and/or potential areas for improvement with respect to the current state of the art: (i) in a shopping complex, advertisements may be displayed based on the of number of people in a common place; (ii) however, there may often be cases where some people are looking at a product or display from a distance; (iii) for this reason, advertisements based on a common point of attraction have the potential to be very important; and/or (iv) by basing an advertisement on a common point of attraction, the advertisement can potentially target a greater number of people.

Some embodiments of the present invention include a method and system by which a user's point of attraction is identified. The point of attraction is identified based on video data analysis and extrapolating the direction of viewing. Once multiple directions of viewing are meeting in a common place, a possible point of attraction is identified. Each point of attraction is ranked based on the number of viewers looking at that common place, and advertisements are displayed accordingly.

Some embodiments of the present invention have the capability to be used not just for advertising but also for capturing information that can be used to determine the effectiveness of store layouts or promotional material. For example, they may be able to: (i) record how many people stop to look at a product or advertisement; (ii) record how long people look at a product or advertisement; (iii) record the ratio of the number of people looking to the number of people buying; and/or (iv) be used to change packaging, retail displays, and so on to make them more effective.

In addition, some embodiments of the present invention may target advertisements by identifying the interests of one or more customers by capturing customer metadata, and, based on this captured metadata, displaying the most popular and relevant advertisement(s) to the customer(s) at a location closest to the customer(s). Metadata may include, but need not necessarily be limited to: (i) customer information; (ii) customer preferences; (iii) customer age; (iv) latest customer interests; (v) latest customer trends; (vi) customer paying potential; (vii) customer tastes; and/or (viii) customer mood.

In some embodiments of the present invention, the metadata is compiled by analysis of data captured using various sensors, cameras, other social data available via the Internet, and so forth. For instance, a photo snapshot used to detect a person's point of interest can also be used to estimate the person's age, a measure which can then be used to average out the age group of the audience. Based on this information, the type or genre of ad to display over the identified point of attraction may be determined. Having determined the age group of the audience around the identified point of attraction along with the geographic location of the advertising board, the system can determine the potential latest trend and interest of that audience by analyzing the general social networking interaction (for example, social networking messages, microblog posts, and so on) taking place by that age group at and around that geographic location. The results may be made more granular and accurate by identifying at least some of the people in the audience and from this deriving each person's on-going public information as available, for example, on social networking sites. Identification may be performed through mechanisms such as biometrics (such as photo detection/facial recognition) or location-based services of personal electronic devices that have been switched on (assuming in each case that any necessary permissions have been obtained from the individuals involved).

By identifying the general paying potential, taste, and mood of the audience around an identified point of attraction, such as by analyzing the type of attire, color of attire, and brands of attire being worn, some embodiments of the present invention use the attributes so identified to select the type or genre of ad to display over an identified point of attraction. For example, if the majority of the audience members are in formal attire then the mood is more formal; if the majority of the audience members are in colorful party attire then the mood is more vacation-type. Attire identified as being from high-end brands may indicate a higher paying potential of audience members. The general tastes of audience members may be identified or deduced in a similar fashion.

In a mall where a number of advertisement boards are available, some embodiments of the present invention may perform one or more of the following actions: (i) gather information about customers around an ad board; (ii) display the most popular ad; (iii) divide the display into parts and display the most popular ads; and/or (iv) identify audience metadata information and display correspondingly more appropriate ads. Note that all this information is dynamic in nature and may change every given interval.

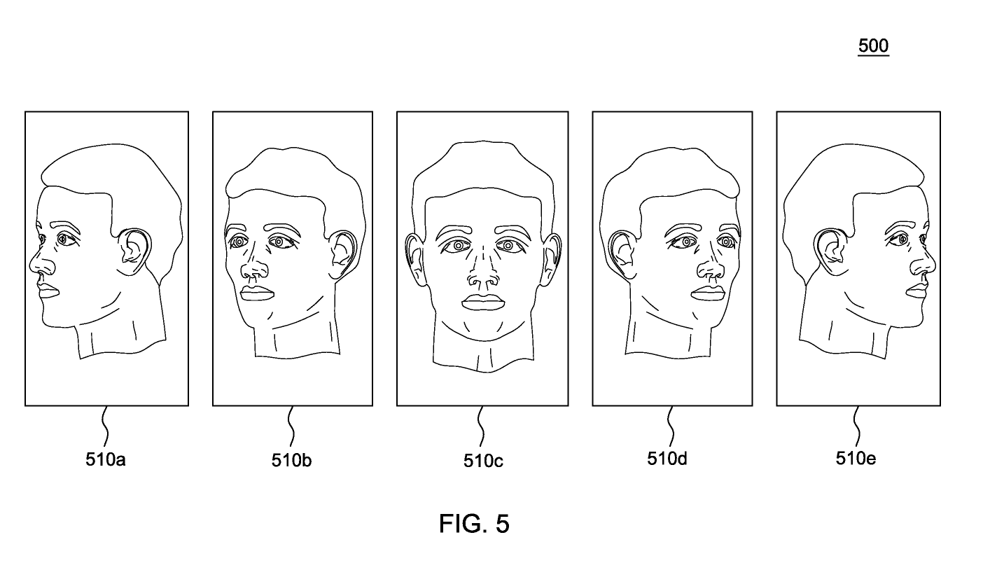

Shown in FIG. 5 is diagram 500, illustrating how, based on a user's facial direction with respect to a fixed point of reference, the user's point of attraction can be determined to be different. Each of frames 510a, 510b, 510c, 510d, and 510e shows the same person's face directed in a different direction: the point of attraction is different in each case. Cameras strategically installed in different directions in a shopping complex can find the point of attraction of each and every person present in the area.

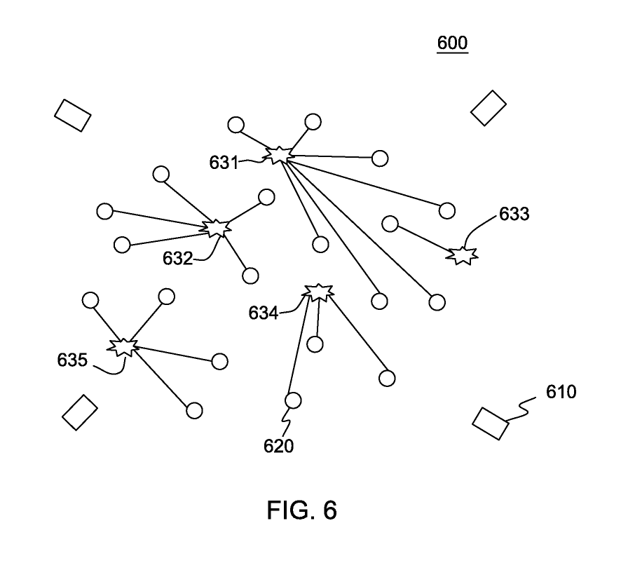

Shown in FIG. 6 is diagram 600, illustrating how, from aggregates of this information, common points of attraction can be identified. Diagram 600 includes: cameras 610; people (viewers) 620; and product displays (showcases) 631, 632, 633, 634, and 635. Diagram 600 shows multiple viewers 620 in a shopping complex, where different products are showcased at different places. The purpose of the showcases is to display a product. The number of people C looking at each product p are: C(p₆₃₁)=7; C(p₆₃₂)=5; C(p₆₃₃)=¹; C(p₆₃₄)=3; and C(p₆₃₅)=4. From the diagram it is clear that more people are looking at product 631 than at any other product. This means more viewers are interested in product 631. So this is an opportunity to display an advertisement on product 631, then product 632, then product 635, and so on. The advertisement will be effective because it will target a larger number of people.

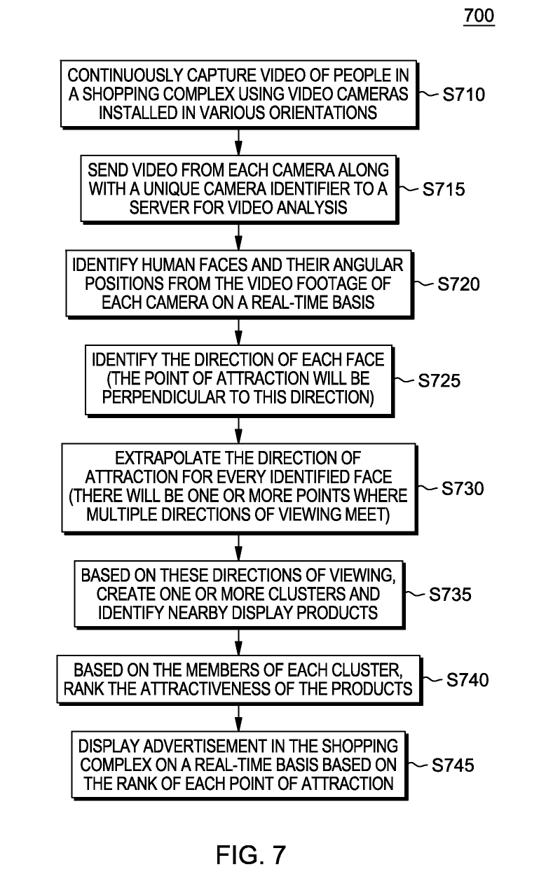

Shown in FIG. 7 is flowchart 700, describing an implementation method used in some embodiments of the present invention. In step S710, video cameras installed in different directions continuously capture video of people in a shopping complex. In step S715, the video from each camera, along with the unique camera number, is sent to a server for video analysis. In step S720, for each and every camera ID, every human face, and the direction (angular position) of each and every human face, is identified on a real-time basis. The video analysis engine then aggregates this information and identifies the direction of each face in step S725—the point of attraction will be perpendicular to the direction of the face (100% identification). In step S730, the video analysis engine extrapolates the direction of attraction for every identified face. There will be one or more points where multiple directions of viewing meet together. Based on the identified directions of viewing, the video analysis engine creates one or more clusters in step S735, and identifies the nearby display products. Now, based on the members in each cluster, the software ranks the products which are more attractive in step S740. Finally, in step S745, advertisements are displayed in the shopping complex on a real-time basis based on the rank of each point of attraction.

Some embodiments of the present invention may include one, or more, of the following features, characteristics and/or advantages: (i) display dynamic genre-based content in response to identified high-affinity viewer points; (ii) include real-time advertisement based on a common point of attraction of different viewers; (iii) include point-of-attraction pattern identification and taking position-based strategic decisions accordingly, such as where to place which product; (iv) are based on a common attraction point of multiple people in a common place; (v) extrapolate different users' directions of focus and identify common meeting points; (vi) gather every customer's metadata; (vii) extrapolate multiple customer's directions of focus to identify a common meting point, and use customer metadata accordingly to deliver advertisements; (viii) advertise to a group by extrapolating the direction of focus of different customers and using customer metadata to deliver an appropriate advertisement; and/or (ix) identify the interests of one or more customers by capturing customer metadata, and, based on the metadata captured, display the most popular and relevant advertisement to the customer(s) at a location closest to the customer(s).

Some embodiments of the present invention may include one, or more, of the following features, characteristics and/or advantages: (i) decide what product to display or advertise on an ad-board in a public place such that the majority of the audience in the defined vicinity of the ad-board is covered, in the sense that the product being advertised is of relevance to the majority of the people around the advertising board or hoarding; (ii) base, at least in part, the analysis and selection of the product to be displayed on what the people are staring at (for example, there may be multiple products being showcased in and around the area); (iii) display relevant ads on an ad-board based on what the majority of people around that ad-board have been looking at in, say, the past 5 minutes (for example, if most of the people were found starting at a mannequin displayed in store X, the board may show an ad for store X, or for a competing product from store Y); and/or (iv) use what people are staring at as only one attribute in the decision as to what will be displayed on a particular ad-board.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

Adaptive content: includes, but is not limited to, advertising content.

Object of visual attention: an object that a human individual is determined to be giving visual attention to, even if that determination is imperfect or inaccurate; may or may not include a content presentation device.

Shared characteristic: can include, but need not be limited to: (i) subject matter similarity (for example, models of birds and written material about birds, or music and headphones); (ii) positional similarity (for example, products on low shelves versus products on high shelves); (iii) functional similarity (such as books, clothing, or food); (iv) price; and/or (iv) ancillary characteristic similarity (such as material, country of origin, or first offer date).

Collective consideration: consideration based on emergent characteristics of a group, such as those derived through aggregation, averaging, and/or categorization (for example, “there are 25 people in this group”, “the average height of people in this group is 5 feet, 8 inches”, “the objects of visual attention currently attracting the most interest are items of clothing”, or “the modal age range of a group of people is 30-40”).

Coincidence of lines of sight: a point or non-point area where the directions of visual attention of two or more persons meet or come into close proximity, with or without regard to any intervening opaque objects; may be one-dimensional (for instance, focused north or south in a corridor); two-dimensional (for example, angular orientation in the horizontal plane); or three-dimensional (angular orientation in both the horizontal and vertical planes); may also take into account degree of coincidence in time.

What is claimed is:

1. A method for presenting adaptive content, the method comprising:
determining one or more objects of visual attention for each person in a plurality of people;
selecting a first adaptive content to be presented through a first adaptive content presentation device based, at least in part, on collective consideration of the objects of visual attention of the plurality of people; and
presenting the first adaptive content through the first device;
wherein:
membership in the plurality of people is based, at least in part, on proximity to the first device; and
the determination of the object of visual attention is performed by computer software running on computer hardware.

2. The method of claim 1 wherein the determination of a first object of visual attention is based, at least in part, on coincidence of lines of sight of at least two people.

3. The method of claim 1 wherein the selection of the first adaptive content is based, at least in part, on a characteristic shared by the objects of attention of the greatest number of people in the plurality of people.

4. The method of claim 3 wherein the characteristic is the identity of the object of attention of the greatest number people in the plurality of people.

5. The method of claim 1 further comprising:
obtaining additional information about at least some of the people in the plurality of people;
wherein:
the selection of the first adaptive content is also based on collective consideration of the additional information.

6. The method of claim 5 wherein obtaining the additional information includes:
determining a first subset of characteristics about at least some of the plurality of people;
gathering, from an electronic network, information about other people who share the first subset of characteristics; and
inferring a second subset of characteristics about the at least some of the plurality of people from collective consideration of the gathered information.

7. The method of claim 1 wherein the presented content comprises one or more advertisements.

8. A computer program product for presenting adaptive content, the computer program product comprising a computer readable storage medium having stored thereon:
first program instructions programmed to determine one or more objects of visual attention for each person in a plurality of people;
second program instructions programmed to select a first adaptive content to be presented through a first adaptive content presentation device based, at least in part, on collective consideration of the objects of visual attention of the plurality of people; and
third program instructions programmed to present the first adaptive content through the first device;
wherein:
membership in the plurality of people is based, at least in part, on proximity to the first device.

9. The product of claim 8 wherein the determination of a first object of visual attention is based, at least in part, on coincidence of lines of sight of at least two people.

10. The product of claim 8 wherein the selection of the first adaptive content is based, at least in part, on a characteristic shared by the objects of attention of the greatest number of people in the plurality of people.

11. The product of claim 10 wherein the characteristic is the identity of the object of attention of the greatest number people in the plurality of people.

12. The product of claim 8 further comprising:
fourth program instructions programmed to obtain additional information about at least some of the people in the plurality of people;
wherein:
the selection of the first adaptive content is also based on collective consideration of the additional information.

13. The product of claim 12 wherein obtaining the additional information includes:
determining a first subset of characteristics about at least some of the plurality of people;
gathering, from an electronic network, information about other people who share the first subset of characteristics; and
inferring a second subset of characteristics about the at least some of the plurality of people from collective consideration of the gathered information.

14. The product of claim 8 wherein the presented content comprises one or more advertisements.

15. A computer system for presenting adaptive content, the computer system comprising:
a processor(s) set; and
a computer readable storage medium;
wherein:
the processor set is structured, located, connected and/or programmed to run program instructions stored on the computer readable storage medium; and
the program instructions include:
first program instructions programmed to determine one or more objects of visual attention for each person in a plurality of people;
second program instructions programmed to select a first adaptive content to be presented through a first adaptive content presentation device based, at least in part, on collective consideration of the objects of visual attention of the plurality of people; and
third program instructions programmed to present the first adaptive content through the first device;
wherein:
membership in the plurality of people is based, at least in part, on proximity to the first device.

16. The system of claim 15 wherein the determination of a first object of visual attention is based, at least in part, on coincidence of lines of sight of at least two people.

17. The system of claim 15 wherein the selection of the first adaptive content is based, at least in part, on a characteristic shared by the objects of attention of the greatest number of people in the plurality of people.

18. The system of claim 17 wherein the characteristic is the identity of the object of attention of the greatest number people in the plurality of people.

19. The system of claim 15 further comprising:
fourth program instructions programmed to obtain additional information about at least some of the people in the plurality of people;
wherein:
the selection of the first adaptive content is also based on collective consideration of the additional information.

20. The system of claim 19 wherein obtaining the additional information includes:
determining a first subset of characteristics about at least some of the plurality of people;
gathering, from an electronic network, information about other people who share the first subset of characteristics; and
inferring a second subset of characteristics about the at least some of the plurality of people from collective consideration of the gathered information.
